(19) United States
(12) Patent Application Publication
(10) Pub. No.: US 2011/0178815 A1
(43) Pub. Date: Jul. 21, 2011

(54) Method for estimating the health risk of a test subject

(76) Inventor: Rene Levett, Vienna (AT)

(21) Appl. No.: 12/998,186

(22) PCT Filed: Jul. 23, 2010
(86) PCT No.: PCT/AT2010/000270

§ 371 Date: Mar. 25, 2011

(30) Foreign Application Priority Data
Aug. 7, 2009 (AT) A 1250/2009

(51) Int. Cl. G06Q 50/00

(52) U.S. Cl. 705/2

(57) ABSTRACT

The invention describes a method to evaluate the health risks of a study subject by comparing blood chemistry risk factors by means of a database with data of multiple patients, sorted by age and sex and concerning their measured risk factors, mortality and causes of death. In order to enable advantageous risk estimation, it is proposed that the risk factor data stored in the database and sorted by sex, age groups and risk factors are combined into value groups according to quantile types with the help of a computer programme, that the study subject is assigned a quantile based on his/her gender and age as well as on his/her risk factor values, that the mortality risk in the study subject's quantile range determined based on the deaths within predetermined mortality periods having a cause that can be referred back to the pertinent risk factors is compared with the corresponding mortality risk of the quantile range of an order that is still safe in regard to the pertinent risk factors, and that the relative mortality risk of the study subject calculated therefrom is indicated as a function of a predetermined threshold value being exceeded.

### FIELD OF THE INVENTION

The invention relates to a method of evaluating the health risks of a study subject by comparing blood chemistry risk factors using a database containing data of multiple patients, sorted by age and sex and concerning their measured risk factors, mortality and causes of death.

### DESCRIPTION OF THE PRIOR ART

It is known that metabolically active substances, and more particularly cholesterol, are one of the risk factors for cardiovascular diseases. The values delimiting the risk range were determined in prospective studies, the results of which are available in the form of databases and which comprise, among other things, the initial findings recorded in deceased study subjects of the same age at least one to ten years before their death. However, with the present documentation it is not possible to evaluate actual health risks on the basis of laboratory data for such risk factors e.g. by introducing specific threshold values without possessing an adequate subject-related education.

### SUMMARY OF THE INVENTION

The purpose of the invention is therefore to indicate a method for the evaluation of the health risk of a study subject by means of the values of his/her risk factors, so that the connection between the values of the risk factors and the health risk can become apparent without the prerequisite of an appropriate subject-related qualification.

The invention fulfils the purpose as formulated by compiling the risk factor data stored in the database and sorted by sex, age groups and risk factors into value groups according to quantile types, by the fact that the study subject is assigned a quantile based on his/her sex and age as well as his/her risk factor values, that the mortality risk determined by means of the deaths within predetermined mortality periods with a cause of death that can be ascribed to the pertinent risk factors is compared in the study subject's quantile range with the corresponding mortality risk of the quantile with an order that is still safe with regard to the pertinent risk factors, and that the relative mortality risk of the study subject determined therefrom is indicated depending on exceeding a predetermined threshold value.

The invention assumes that a sufficient number of deaths will be available in databases for the evaluation of the health risk as well as the measured risk factors of the patients examined and the causes of death, which is also actually the case. In fact, these data volumes make it possible to provide a meaningful distribution of the recorded values of the individual risk factors in relation to the total number of patients examined, subdivided by sex and age as well as by other criteria if applicable, such as living or social environment, which is an essential prerequisite for accurately estimating the health risk of a study subject. The risk factor values are combined for all patients of a given gender and age group. In this method, the data from the patient's baseline visits are used anonymously, i.e. the fasting risk factor values in blood are evaluated before any potential treatment of the risks evidenced by the said factors; this is done within a multi-cohort study. In this connection, because of the existing range of blood chemistry risk factors it is possible that, as a result of pathogenicity, a new risk factor not yet mentioned by the professional associations could, in certain circumstances, be indicated as a principal risk factor.

The distribution of the risk factor values is recorded on the basis of their distribution density, by combining the values themselves into groups and sorting them by the sex and age groups of the patients being studied.

This means that the values of the risk factors can be combined into quantiles, where the number of risk factor values in each quantile corresponds to the number of patients pertaining to that quantile and recorded in the database. If a quantile can be assigned a threshold value that is meaningful for the pertinent risk factor for the health risk, the values of the risk factors in the individual quantile ranges can be examined for risk relevance. To determine the pertinent threshold values for the risk factors, it is possible to use the data available in the database itself advantageously, if it is at first determined that in risk factors having a risk that increases with their values there is still a safe value if only a particular percentage of the recorded patients evidence a risk factor under this value, i.e. that they belong to a quantile of a pertinent order. In fact, then the mortality risk in the range of the quantile that can be assigned to the study subjects based on their gender, age and risk factor values can be compared with the mortality risk in the range of the corresponding quantile in terms of sex and age that is nonetheless still safe in terms of risk factors, in order to be able to calculate and indicate the relative mortality risk for the study subject from this information if the study subject's mortality risk significantly increases as compared to the mortality risk in the range of the quantile of a still safe order with regard to risk factors.

In general, the threshold value can be considered to be a doubling of the mortality risk, thus indicating a health risk to the study subject in the form of the relative mortality risk. Using the death cases recorded within a predetermined mortality period of, for example, 5 or 10 years that can be assigned to the individual risk factors based on the causes of death, it is therefore possible to derive the relative mortality risk depending on the threshold value as calculated in each case.

It can usually be assumed that it can be said that there is no risk potential if 20% of the recorded patients have risk factors in one range of values that in regard to the health risk connected therewith is more favourable than the pertinent range of values of the remaining 80% of patients.

This means that the quantile of order 0.2, i.e. the pentile of the first order, determines the threshold values and thus also mortality risk that is not increased by risk factors. However, the prerequisite is that the number of mortalities recorded in the pertinent mortality periods is sufficient for meaningful evaluation. Otherwise, the number of patients recorded must be increased, e.g. by expanding the pertinent age group. On evaluating the health risk depending on specific risk factors, age naturally plays a substantial role with regard to a limited mortality period of e.g. 5 or 10 years, so that it is definitely possible that the age range under examination will have to be expanded for young study subjects in order to be able to have a sufficient corpus of cases within the predefined mortality periods.

To enable a meaningful estimation of the health risk, it is recommended to use glucose and gamma glutamyl transferase as risk factors in addition to total cholesterol, HDL cholesterol and triglycerides, i.e. risk factors that relate in particular to ischaemic heart disease as well as to diseases of the circulatory and cerebrovascular systems. The threshold values dividing the risk range from the non-risk range can be defined as 200 mg/dl total cholesterol, 40 mg/dl HDL cholesterol for men and 50 mg/dl for women, 200 mg/dl triglycerides, 110 mg/dl glucose and 18 U/I gamma glutamyl transferase for women and 28 U/I for men. However, because of the threshold value determination via the quantile of a still safe order with regard to risk factors, it becomes obvious that there is already a higher degree of risk even if the said threshold values are not exceeded, in particular when risk factors are cumulated. With the method according to the invention it is therefore possible also to represent the impact of the individual risk factors on the risk to health by showing the changes in relation to the relative mortality risk by entering different values for the individual risk factors.

The method according to the invention possesses the advantage that the health risk is not indicated based on specialist knowledge, but that it is derived on the basis of recorded risk factor value distributions related to all pertinent patient groups, where the reciprocal impacts of the risk factors can be taken into account if sufficiently large groups of values are admitted in order to be able to indicate the relative mortality risk by means of several simultaneous risk factors within a risk range on the basis of the number of patients examined. For this purpose, it is possible advantageously to combine the range of values advantageously recorded by percentiles for purposes of the ease of evaluation of the risk factors into pentiles and/or deciles. If several risk factors indicate an increased risk, risk relevance and significance are confirmed.

In the presence of an increased relative mortality risk, e.g. by a factor of 1.5 to 2, in the prevention phase, i.e. before any symptoms make their appearance, and independently of any specialist medical treatment, the study subject can take action in relation to his/her body weight, tobacco consumption and, depending on the risk factor result, even on his/her alcohol consumption by means of a change in dietary habits.

Standard computers can be used to implement the method if equipped with an appropriate programme for processing data queried from a database for risk factors of previously examined patients, so that the relative mortality risk for different entered values of the said risk factors can be indicated in accordance with the explanations set forth above by means of the distribution density of the values of the recorded risk factors. A variation of the risk factor values entered for a study subject can also help clearly represent the impact of such blood chemistry risk factors on the health risk affecting the study subject.

1. Method to evaluate the health risks of a study subject by comparing blood chemistry risk factors by means of a database with data of multiple patients, sorted by age and sex and concerning their measured risk factors, mortality and causes of death, wherein, with the help of a computer program, the risk factor data stored in the database and sorted by sex, age groups and risk factors are combined into value groups by way of quantiles, wherein the study subject is assigned a quantile depending on his/her gender and age as well as on the values of the risk factors, wherein the mortality risk in the study subject's quantile range calculated by means of the deaths within predefined mortality periods that are ascribable to a cause that can be referred back to the pertinent risk factors is comparted with the corresponding mortality risk of the quantile range of an order that is still safe with regard to the pertinent risk factors, and wherein the relative mortality risk of the study subject calculated therefrom is indicated as a function of a predetermined threshold value being exceeded.

2. Method according to claim 1, wherein the quantile of a still sage order with regard to the pertinent risk factors is defined as being the quantile comprising 20% of all recorded patients.

3. Method according to claim 1, wherein the threshold value for the indication of an increased relative mortality shall be 2.

4. Method according to claim 1, wherein in addition to total cholesterol, HDL cholesterol and triglycerides, glucose and gamma glutamyl transferase are measured as risk factors.
